(19) United States
(12) Patent Application Publication
(10) Pub. No.: US 2026/0289411 A1
(43) Pub. Date: Sep. 24, 2026

(54) AUTOMATED VALUATION MODEL (AVM) AND TECHNIQUES FOR REDUCING LEAKAGE IN MACHINE LEARNING DATASETS

(71) Applicant: Newmark & Company Real Estate, Inc., New York, NY (US)

(72) Inventors: Vinicio DeSola, JR., Edgewater, NJ (US); Robert McDonald, New York, NY (US); Prithvi Raj, New York, NY (US); Gia Nguyen, Glenshaw, PA (US)

(21) Appl. No.: 19/573,554

(22) Filed: Mar. 20, 2026

Related U.S. Application Data
(60) Provisional application No. 63/775,737, filed on Mar. 21, 2025.
(60) Provisional application No. 63/938,798, filed on Dec. 11, 2025.

(51) Int. Cl. G06N 20/00

(52) U.S. Cl. CPC G06N 20/00

(57) ABSTRACT

System, apparatus and method may control receiving time-indexed data comprising values of a plurality of features; generating derived features based on temporal changes of at least one of the plurality of features, the derived features including at least a first derivative of a first value; temporally aligning the plurality of features and the derived features to a reference date such that only data available prior to the reference date is used for training a machine learning model; training a machine learning model on the temporally aligned features and the derived features to predict a forward-looking value; and outputting the forward-looking value.

### CROSS REFERENCE TO RELATED APPLICATIONS

This application claims the benefit of and priority to U.S. Patent Application Nos. 63/775,737 filed Mar. 21, 2025 and 63/938,798 filed Dec. 11, 2025, the contents of which are incorporated in their entirety by reference herein.

### BACKGROUND

Machine learning (ML) involves computer algorithms or models that use data to make inferences. To implement machine learning, the computer algorithm or ML model may be configured to process training data during a training process. Once the ML model is trained, it can generate inferences without being explicitly programmed to do so.

Datasets are prolific in today's world. Some datasets include information that is irrelevant or out-of-date because it is often difficult to choose data that is relevant and timely for an accurate analysis. When the data is improper or the model is improperly trained, an inaccurate inference can be generated.

For example, some datasets are used to estimate a value of an item, yet the estimate may rely on improper data in the dataset and create an inaccurate estimate. In estimating building rental or lease prices, for example, the estimates may rely on outdated listings or public records that do not reflect current market conditions.

### SUMMARY

In accordance with an aspect of the present disclosure, a system may include at least one processor configured to: receive time-indexed data comprising values of a plurality of features; generate derived features based on temporal changes of at least one of the plurality of features, the derived features including at least a first derivative of a first value; temporally align the plurality of features and the derived features to a reference date such that only data available prior to the reference date is used for training a machine learning model; train a machine learning model on the temporally aligned features and the derived features to predict a forward-looking value; and output the forward-looking value.

In accordance with aspects of the present disclosure, a method may include controlling, by at least one processor: receiving time-indexed data comprising values of a plurality of features; generating derived features based on temporal changes of at least one of the plurality of features, the derived features including at least a first derivative of a first value; temporally aligning the plurality of features and the derived features to a reference date such that only data available prior to the reference date is used for training a machine learning model; training a machine learning model on the temporally aligned features and the derived features to predict a forward-looking value; and outputting the forward-looking value.

### BRIEF DESCRIPTION OF THE DRAWINGS

The present disclosure, in accordance with one or more various examples, is described in detail with reference to the following drawings. The drawings are provided for purposes of illustration only and merely depict typical, non-limiting aspects of such examples.

FIG. 1 illustrates a dataset generation system, dataset data store, and user terminal, according to various aspects of the present disclosure.

FIG. 2 illustrates a data staging process, according to various aspects of the present disclosure.

FIG. 3 is an illustrative list of features, according to various aspects of the present disclosure.

FIG. 4 illustrates a set of windows that comprise data backward in time from a particular date, according to various aspects of the present disclosure.

FIG. 5 illustrates a short term window and a long term window that comprise data backward in time from a particular date, according to various aspects of the present disclosure.

FIG. 6 illustrates a portion of a derivative process to generate velocity, speed, and acceleration of interest rate, according to various aspects of the present disclosure.

FIG. 7 illustrates a process associated with an interest rate, according to various aspects of the present disclosure.

FIG. 8 illustrates a user interface at a terminal, according to various aspects of the present disclosure.

FIG. 9 illustrates a portion of a derivative process to generate velocity, speed, and acceleration of inflation, according to various aspects of the present disclosure.

FIG. 10 illustrates geospatial mapping associated with a dataset, according to various aspects of the present disclosure.

FIG. 11 illustrates a user interface at a terminal, according to various aspects of the present disclosure.

FIG. 12 is an example method of reducing leakage in generating a dataset, according to various aspects of the present disclosure.

FIG. 13 is a computing component according to various aspects of the present disclosure.

FIG. 14 is a computing component according to various aspects of the present disclosure.

FIG. 15 depicts a block diagram of an example computer system according to various aspects of the present disclosure.

### DETAILED DESCRIPTION

Existing approaches to automating valuation of real estate properties using ML models, such as those aiming to predict a price per square foot of lease space, can achieve, at best, 75-80% accuracy even when utilizing high-quality, large datasets with samples numbering in the thousands to tens of thousands. One approach to increasing accuracy of such models includes generating yet larger datasets, e.g., with rows totaling hundreds of thousands or millions, and having training and validation routines that can require vast AI-accelerating hardware resources, e.g., graphic processing units (GPU), processor and compute time, memory, bandwidth, and power consumption.

According to the present disclosure, models aiming to increase the accuracy in forward-predicting (or forward-looking) value estimations may be achieved (i) without necessarily requiring datasets with ever-increasing amounts of data, i.e., rows of data, and (ii) thus by extension, that reduce or otherwise minimize hardware usage including, importantly, the overall number of GPUs, the virtual random access memory (VRAM) size of the GPUs, the processor and compute time, and the overall system memory size and usage during training, validations and valuations. In one example, datasets may be augmented or otherwise modified to include derived features that represent the force and effect of conditions which, as demonstrated below with reference to the methodologies and experimental results, were identified as having a disproportionate impact on model accuracy. In one example in accordance with the present disclosure, a training dataset with as few as 1200 to 2500 total rows and having a baseline valuation accuracy of about 75-80% without the benefit of the derived features and temporal alignment disclosed herein, may be augmented to achieve greater than about 94% accuracy without increasing the overall sample size, as demonstrated by the experimental results detailed herein.

Put plainly, features for training of forward-predicting models for valuations, according to the present disclosure, advantageously improve upon existing approaches to training of valuation models. Such existing approaches typically leverage raw market data commonly used to market properties to buyers and lessees (e.g., square foot, location). In contrast, aspects and features of the present disclosure include dataset generation, and training and validation of models for forward-predicting valuation that leverage derivations of data and temporal alignment schemes to achieve temporal alignment of data and avoid data leakage.

In accordance with some embodiments of the present disclosure, it has been observed that interest rates significantly impact the accuracy of forward-predicting valuation models, and in addition, that while such interest rates can be expressed as a scalar value in training datasets, representing interest rates utilizing derivative processing techniques consistent with the present disclosure to represent velocity and acceleration of interest rates may provide an additional dimension of data to training datasets which significantly increases accuracy, e.g., by about 10% or higher, as discussed further below in the experimental results. In addition, in accordance with some embodiments of the present disclosure, it has been observed that the accuracy-enhancing benefits of quantifying interest rates in such a multi-dimensional manner may be negated absent data leak safeguards, specific example implementations and features of which are provided herein.

In accordance with some embodiments of the present disclosure, the correct data that is relevant to use for a particular analysis, which is to say avoid data leakage, may be identified, by ensuring that the data in the dataset corresponds to a relevant time range. For example, a forward-looking prediction from a historical date (January 1^{st}) cannot use data that was released after the historical date (January 2^{nd}), especially in a time series dataset. The analysis needs to generate the forward-looking prediction from data that existed on the historical date. This data identification process is particularly applicable in time series datasets. The identification of the data that existed on the historical date may be implemented by matching and masking data that is available on the historical date and limiting the data to what is relevant to the analysis and prediction. As such, the data identification process may create a “window” of data (e.g., a subset of data selected from a larger dataset where nearby values are relevant) to use in the analysis to create a forward-looking prediction.

Similarly, when generating a “velocity” (e.g., a rate of change in the data over time) or “acceleration” (e.g., a rate of change in the data velocity over time) of the data from the historical date, in accordance with the present disclosure, a time series model may use the available or observable values from the historical date or date range to the exclusion of values from periods after the target date or date range, e.g., from a future period of time. When data is provided to the time series model that would not have been available on the historical date or during the date range, the time series model is referred to as having “data leakage” and the time series model may generate an inaccurate forward-looking prediction.

In various instances, the generation of the velocity or acceleration value from the particular historical date may access a window of data to determine an interest rate or inflation rate associated with the real estate property as of the historical date. In this case, the velocity or acceleration of the data may be determined by calculating a first or second derivative, respectively, of the interest rate or inflation rate, and adjusting the window of data to temporally align the data with the historical date (e.g., inflation rate data that is one month older than the inflation rate on the date of the lease signing or interest rate data that is one day older than the interest rate on the date of the lease signing). The temporal alignment using the window of data according to the present disclosure may help minimize or otherwise reduce data leakage. As such, the derivative or temporal alignment of the data in accordance with the present disclosure may be used to compute a final dataset value using the equations described herein (e.g., the first and second derivatives of values, quarterly (QoQ) differences in velocity or acceleration, annual (YoY) differences in velocity or acceleration, etc.). While aspects and examples disclosed herein refer specifically to derivative values based on interest rates and/or inflation rates, the present disclosure is not limited in this regard. Aspects of the present disclosure are equally applicable to quantifying the force and effect of other values that may be represented in a non-linear model as a derived feature including, but not limited to, velocity and acceleration.

Various technical improvements are described throughout the present disclosure. For example, the temporal alignment of the dataset and derivative analysis of the dataset may help ensure that data leakage may be minimized or otherwise reduced and the accuracy of the forward-looking prediction may be improved including, in one example, the prediction of a price per square foot of the real estate property corresponding to a lease term of the real estate property.

An exemplary implementation of the present disclosure for predicting a lease price for a real estate property is described in detail below. It is to be understood, however, that a rental price or sale price for a real estate property may be predicted in a same or similar manner in accordance with aspects of the present disclosure.

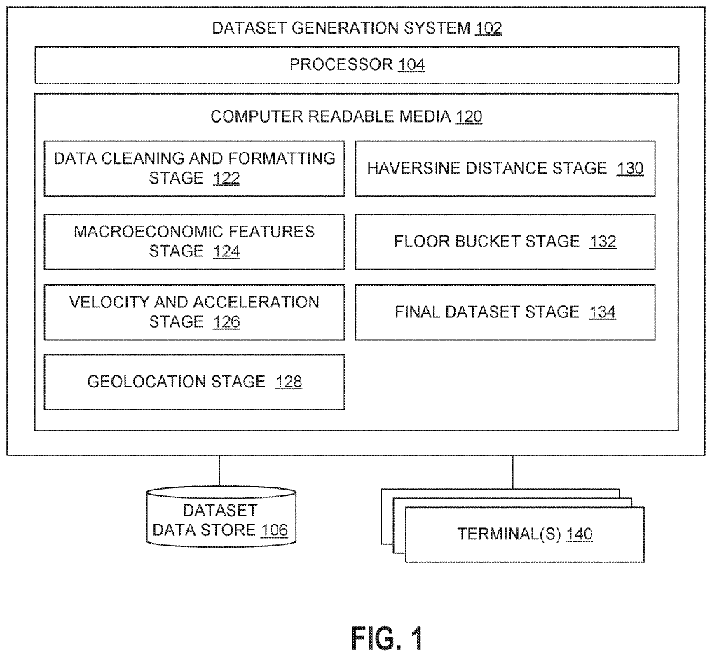

FIG. 1 illustrates a dataset generation system 102, dataset data store 106, and user terminals 140, according to various aspects of the present disclosure. The dataset generation system 102 may include a processor 104, which may also be referred to herein as a hardware processor, and a computer readable media 120.

Hardware processor 104 may be one or more central processing units (CPUs), semiconductor-based microprocessors, and/or other hardware devices suitable for retrieval and execution of instructions stored in computer readable memory storage medium 120. Hardware processor 104 may fetch, decode, and execute instructions to control processes or operations for reducing leakage in datasets. As an alternative or in addition to retrieving and executing instructions, hardware processor 104 may include one or more electronic circuits that include electronic components for performing the functionality of one or more instructions, such as a reprogrammable hardware device including, for example, a field programmable gate array (FPGA), an application-specific integrated circuit (ASIC), or other electronic circuits.

A computer readable memory storage medium, such as computer readable memory storage medium 120, may be any electronic, magnetic, optical, or other physical storage device that contains or stores executable instructions. Thus, machine-readable storage medium 120 may be, for example, random-access memory (RAM), non-volatile RAM (NVRAM), electrically erasable programmable read-only memory (EEPROM), a storage device, an optical disc, and the like. In some embodiments, computer readable memory storage medium 120 may be a non-transitory computer readable memory storage medium, where the term “non-transitory” does not encompass transitory propagating signals. As described in detail below, computer readable memory storage medium 120 may be encoded with executable instructions.

The computer readable memory storage medium 120 may also comprise various components, engines, or other logic embodied in hardware, firmware, or software instructions. These components may be configured for execution by the hardware processor 104 using the instructions embodied in each component, including a data cleaning and formatting stage 122, a macroeconomics features stage 124, a velocity and acceleration stage 126, a geolocation stage 128, a Haversine distance stage 130, a floor bucket stage 132, and a final dataset stage 134.

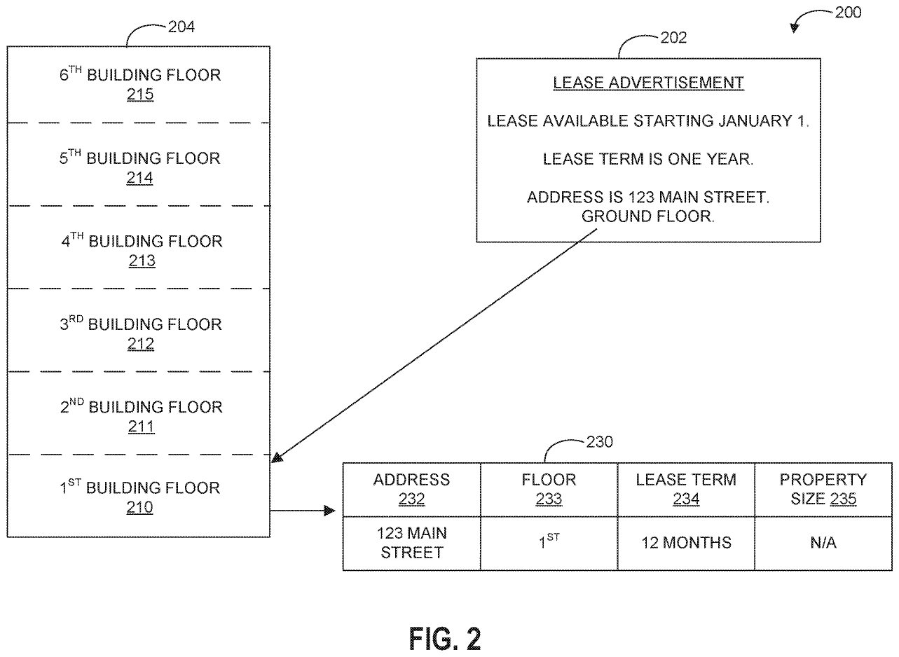

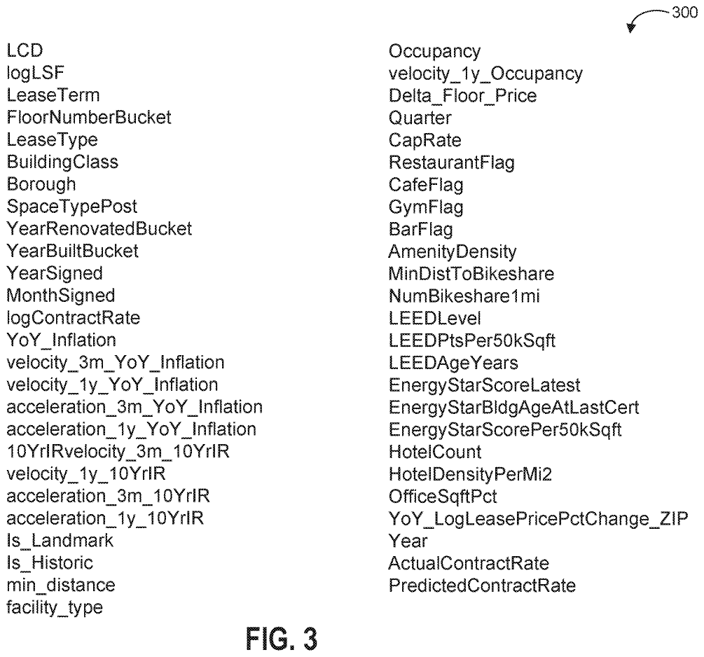

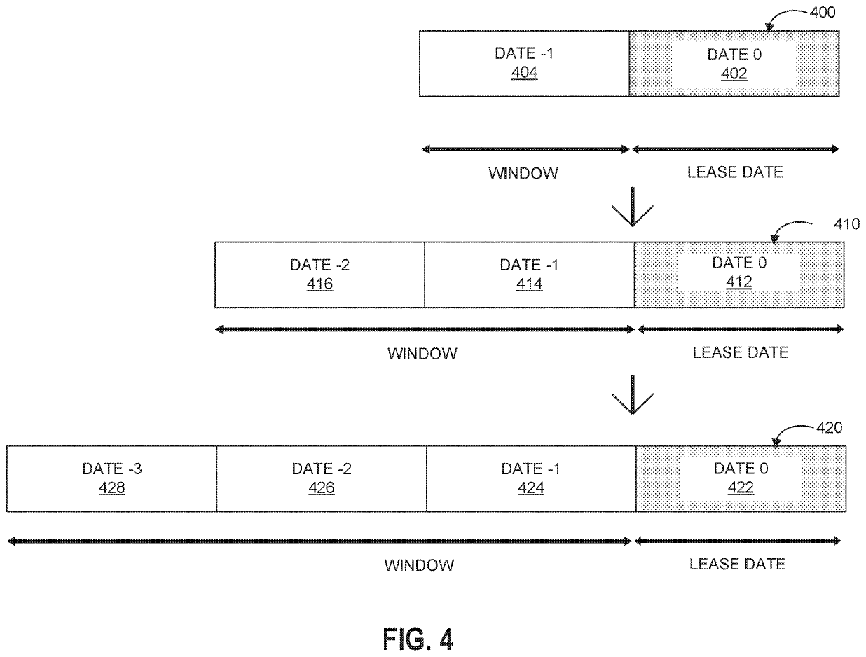

Data cleaning and formatting stage 122 may be configured to receive and clean various types of data and store the data in dataset data store 106. The data may include time information indicating a date or time period to which the data corresponds or when the data is generated, i.e., time-indexed data. The dataset data store 106 may store one or a plurality of datasets in accordance with the present disclosure. The datasets stored in the data store 106 may be scalar values and/or derived values derived from features as discussed further below with reference to FIGS. 2 and 3, as well as utilizing data analysis and generation techniques in accordance with the present disclosure, such as a sliding time window scheme and derivative processing to generate velocity and acceleration as discussed further below with reference to FIGS. 4-9. The datasets may be stored in the data store 106 in a human-readable format, such as a comma delimited list of columns and values or JavaScript Object Notation (JSON).

The datasets stored in the data store 106 may include, for example, occupancy data, Consumer Price Index (CPI) data, interest rate data, and geolocation data represented as a scalar value. Occupancy data may be cleaned and formatted by receiving an occupancy value in a date range and standardizing the occupancy data to a monthly frequency. Missing values in the occupancy data may be interpolated, for example, by forward filling the current occupancy at a given ZIP code using the previous two months of occupancy values. If no occupancy values are available for that ZIP code, a default occupancy value equal to the mean occupancy of the broader market may be used. CPI data may be cleaned and formatted by seasonally adjusting and standardizing the CPI data to a chosen base period. Interest rate data may be cleaned and formatted by standardizing the interest rates to a monthly rate and correcting (i.e., deleting or removing) any outliers or anomalies. Geolocation data may be cleaned and formatted by standardizing latitude and longitude coordinates.

In some examples, a price value may be determined using various data, including address, floor number, lease type, lease term, year renovated, and/or a size of space (e.g., square feet). This data and other data may help determine an accurate estimate of the price value of a real estate property using systems and methods in accordance with the present disclosure given the economic preferences of, for instance, both the other of the real estate (e.g., landlord) and tenant.

In some examples, the dataset may include whether the building is a landmark or historic place. The real estate property may be designated as a landmark or historical as denoted by the municipality or national register of historic places. The real estate property may be matched by an address in the dataset data store 106 and the address in a National Register of Historic Places.

In some examples, the dataset may include a building class through a rule-based approach. The real estate property may include a subjective building categorization that reflects the quality relative to the overall quality of buildings in the market. The building class may be determined using a trained machine learning model.

In some examples, the dataset may include a year built bucket. The year built bucket may correspond to the year that the real estate property was constructed. The real estate properties may be aggregated by a range (e.g., built 2010-2012). The year built data may be received from the Tax Assessor Office.

In some examples, the dataset may include a year renovated bucket. The year renovated bucket may correspond to the year that the real estate property had major repairs and/or upgrades (e.g., in excess of $10k, etc.). The real estate properties may be aggregated by a range (e.g., renovated 2010-2012). The year renovated bucket may be received from the Tax Assessor Office.

In some examples, the dataset may include a distance to and categorical facility type of the closest transportation hub from the real estate property. For example, the data may include how far the real estate property is from the closest transportation hub (e.g., Grand Central Terminal or John F. Kennedy Airport). The categorical facility type may correspond to the type of transportation (e.g., subway, airport). The data associated with the transportation hub may be received from the Department of Transportation.

In some examples, the dataset may include a zip code-level occupancy of real estate properties and changes to the occupancy data. For example, the dataset may include a year-over-year (YoY) change in occupancy. The dates of the occupancy data may include the lease status at time the lease was created or signed.

In some examples, the dataset may include various types of interest rates, including a 10-year Treasury rate, a quarter-over-quarter (QoQ) (three-months) change in the 10-year Treasury rate, a QoQ Acceleration in 10-year Treasury rate, a YoY change in 10-year Treasury rate, and a YoY Acceleration in 10-year Treasury rate, to name a few. Any acceleration data associated with the Treasury rate may identify a change in the quarterly and/or annual difference of 10-year Treasury rates from which to determine the acceleration (positive or negative) of interest rate movement.

In some examples, the dataset may include a QoQ inflation velocity at time of a signed lease. The quarterly percentage may identify the change in CPI to determine the short-term price momentum. Various other inflation data may be received or determined, including a QoQ inflation acceleration at time of a signed lease, a YoY inflation at time of a signed lease, a YoY inflation velocity at time of a signed lease, and a YoY inflation acceleration at time of a signed lease, to name a few.

In some examples, the dataset may include YoY contract rate percentage change. The YoY contract rate percentage change may be aggregated by zip code or another geographic identifier. The YoY contract rate percentage change may be translated from a difference (delta) value to a logarithmic value of the YoY contract rate percentage change. The YoY contract rate percentage change may be associated with a log-transformed value of the YoY contract rate percentage change of the real estate property in the signed lease.

In some examples, the dataset may include a lease type and property type of the real estate property. The options of lease types may include, for example, full gross or modified gross. The options for property types may include, for example, medical office, government office, or other name that may be transformed into a determined list of property types.

In some examples, the dataset may include a value of the leasable square feet of the real estate property. In some examples, the leasable square feet may be translated to a logarithmic value of the leasable square feet. The leasable square feet may be associated with a log-transformed value of the leasable square feet of the real estate property in the signed lease.

In some examples, the dataset may include a floor number bucket. The floor number bucket may include a story of the real estate property where the leasable space is located. The real estate properties may be aggregated by a range (e.g., building floor 32 in a bucket of floors 30-40).

In some examples, the dataset may include a lease term and cap rate from the signed lease. For example, the lease term may include the length of the lease of the real estate property, and the cap rate may correspond to the time the owner purchased the real estate property associated with a lease term.

In some examples, the dataset may include a timing of the lease (e.g., quarter, Q1/Q2/Q3/Q4, month, or year). The timing of the lease may be identified from the signed lease associated with the lease commencement date.

In some examples, the dataset may include various environmental rankings, including a LEED certification level and an Energy Star Rating of the real estate property. Values may be determined from the rankings as well, including a LEED certification age, LEED Points per 50,000 (“50K”) square feet (“SqFt”), Building Age at Last Energy Star Certification, and Energy Star Ratings per 50K SqFt. The real estate property may be matched by an address in the dataset data store 106 and the address in a LEED or Energy Star data store.

In some examples, the dataset may include a zip code-level office density. The office density may include a value (e.g., percentage) of the space of the real estate property in a given zip code that is denoted as office (e.g., ratio of total office space vs. total building SqFt).

In some examples, the dataset may include bike-share information location. For example, the data may include the distance between the real estate property and the closest bike share station. The data may also comprise the density of bike-share locations (e.g., the number of bike-share docks within a 1-mile radius of the real estate property).

In some examples, the dataset may include a difference in a price value between lease locations in the same real estate property. For example, the dataset may include a computed delta in price between higher floors and lower floors with respect to the lease location.

In some examples, the dataset may include a borough of the real estate property. For example, in New York City (NYC), one of five boroughs is available for the location of the real estate property and may be identified in the dataset (e.g., Manhattan, Brooklyn, Queens, Bronx, or Staten Island).

In some examples, the dataset may include whether certain amenities are available in the real estate property. For example, the dataset may identify whether the real estate property has at least one bar, café, gym, or restaurant. The identification of each of the amenities may be stored as a binary value (0=not present, 1=present).

In some examples, the dataset may include an aggregate value of the amenities in the real estate property. For example, the dataset may count distinct amenity types present in the real estate property, based on binary flags for features such as gym, bar, cafe, etc. Each amenity type may contribute at most one point, regardless of the quantity of the amenity.

In some examples, the dataset may include information about hotels in the geographic area. For example, the dataset may determine the total number of hotels located within a one-mile radius of the zip code centroid where the real estate property is located (e.g., based on geospatial proximity). In other examples, the dataset may include a hotel density (e.g., per sq. mile) to identify a number of hotels within a one-mile radius buffer of the zip code centroid, calculated by dividing the hotel count by the area in square miles.

Macroeconomics features stage 124 may be configured to determine a particular time range for the data in the dataset that would have been known at the time the lease was created or signed. This determination may help temporally align or match the data with the particular date of the signed lease. The data may include macroeconomic indicators such as interest rate, inflation rate and CPI. For example, the interest rate may be identified for the business day prior to the date of the signing (e.g., sign the lease on May 15 and access the interest rate from May 14). In another example, the inflation rate may be identified for the month prior to the date of the signing.

It is to be understood that, in accordance with aspects of the present disclosure, macroeconomic indicators may include any indicator of future economic activity that may relate to predicting a price, such as, for example, a lease price based on Consumer Confidence Index (CCI), unemployment rate and the like.

Macroeconomics features stage 124 may be configured to identify additional information about the owner of the real estate property or the tenant. For example, for the owner, the macroeconomic features may be analyzed and/or generated to determine the intent of the owner of the real estate property (e.g., whether the owner is prioritizing occupancy or lease price maximization). The macroeconomic features for the tenant, for example, may be used to identify creditworthiness through a cohort analysis.

Velocity and acceleration stage 126 may be configured to calculate adjustments to various data described herein. For example, the adjustment may correspond to calculating a derivative of the value (e.g., interest rate and/or inflation rate). The adjustment may also temporally align the data (e.g., the interest rate and/or inflation rate) with the lease signing date, e.g., inflation rate data that is one month older than the inflation rate on the date of the lease signing or interest rate data that is one day older than the interest rate on the date of the lease signing. The temporal alignment may help reduce leakage in the dataset. The derivative or temporal alignment of the data may be used to compute the final dataset value that is stored in dataset data store 106 using the equations described herein.

In some examples, a velocity of occupancy (e.g., month-over-month percentage changes in occupancy) is computed by:

$$Occupancy {Velocity}_{t} = \frac{Occupancy {Rate}_{t} - Occupancy {Rate}_{t - 1}}{Occupancy {Rate}_{t - 1}} \times 100 \qquad Equation 1.$$

In some examples, a velocity of the interest rate (e.g., month-over-month percentage changes in interest rates) is computed by:

$$Interest Rate {Velocity}_{t} = \frac{Interest {Rate}_{t} - Interest {Rate}_{t - 1}}{Interest {Rate}_{t - 1}} \times 100 \qquad Equation 2.$$

In some examples, an acceleration of the interest rate (i.e., rate of change of velocity of the interest rate) is computed by:

$$Interest Rate {Acceleration}_{t} = \frac{Interest Rate {Velocity}_{t} - Interest Rate {{Velocity}_{t}}_{- 1}}{Interest Rate {{Velocity}_{t}}_{- 1}} \times 100 \qquad Equation 3.$$

In some examples, a velocity of the CPI data (e.g., month-over-month percentage changes in CPI) is computed by:

$$CPI {Velocity}_{t} = \frac{{CPI}_{t} - {CPI}_{t - 1}}{{CPI}_{t - 1}} \times 100 \qquad Equation 4.$$

In some examples, an acceleration of the CPI data is computed by:

$$CPI {Acceleration}_{t} = \frac{CPI {Velocity}_{t} - CPI {Velocity}_{t - 1}}{CPI {Velocity}_{t - 1}} \times 100 \qquad Equation 5.$$

Geolocation stage 128 may be configured to determine whether the real estate property is a landmark or historical building. The real estate property may be matched by an address in the dataset data store 106 for the real estate property and the address in a National Register of Historic Places. In some examples, either address may be adjusted to a different format (e.g., longitude and latitude) so that the addresses may match each other.

Haversine distance stage 130 may be configured to calculate accurate distances from the real estate property to other locations, like potential transportation hubs or other amenities. The distance may be determined using a Haversine distance. In some examples, a Haversine Distance is computed by the following formula, where r is Earth's radius, φ and λ are a latitude and longitude, respectively.

$$d = 2 r arcsin ( \sqrt{{sin ( \frac{{φ}_{2} - {φ}_{1}}{2} )}^{2} + cos ( {φ}_{1} ) cos ( {φ}_{2} ) sin {( \frac{{λ}_{2} - {λ}_{1}}{2} )}^{2}} ) \qquad Equation 6.$$

Floor bucket stage 132 may be configured to determine a difference in the price value between units in the real estate property. To capture pricing differences among floors in the real estate property, a reference group may be first established (e.g., floors Ground through 10). Floor bucket stage 132 may identify each floor's membership in either a reference group range or a higher-floor group of units (e.g., a “bucket” of floors 20 and above). Floor bucket stage 132 may compute the average lease price metric (e.g., log(contract rate)) within each group, by location (e.g., zip code) and time period (e.g., quarter) and subtract the reference group's average rate from the high-floor group's average rate. This computation may quantify how high-floor pricing compares to the reference group.

Floor bucket stage 132 may also be configured to handle missing data. For example, where direct matches are not available (e.g., no reference data is available for a given quarter), the stage may use fallback group averages or fill from neighboring time periods. For any floor belonging to the reference group, the floor-delta is set to zero. Once calculated, the resulting delta floor price value may identify a continuous or discrete measure of the expected pricing difference between reference and high floors in each location, real estate property, and time period.

Final dataset stage 134 may be configured to add calculated velocity values, acceleration values, and geolocation associations to dataset data store 106. The values may be merged and/or combined, in some cases, for a single real estate property. These and other values may be provided to terminal 140, including the velocity value and the acceleration value.

The terminal 140 may provide a user interface to display the velocity value and the acceleration value, or provide interface features to interact with the data. For example, the terminal 140 may enable sliding scales to identify the movement of and difference in the lease prices on a particular date. This displayed information may help illustrate the direct correlation between a single feature and the predicted lease price on the particular date.

FIG. 2 illustrates a data staging process 200, according to various aspects of the present disclosure. For example, a lease advertisement 202 or other data may identify a real estate property for lease. The lease advertisement 202 may include various information, including a date that the real estate property is available (“lease available starting January 1”), the lease term available (“lease term is one year”), and an address of the real estate property (“address is 123 Main Street, ground floor”). The date of the lease signing may not be available in the lease advertisement 202 and may be provided in a separate data source.

The data staging process 200 may include converting and/or formatting the address to a standardized format for the dataset. For example, lease advertisement 202 may include a first format for a building floor of the address (e.g., “ground floor”) and may convert the building floor to a second format 210 (“first building floor”). Other values may be used in the second format 211, 212, 213, 214, and 215 as well (e.g., “second building floor,” “third building floor,” “fourth building floor,” “fifth building floor,” “sixth building floor,” respectively).

The data staging process 200 may also include cleaning missing data for the dataset. For example, lease advertisement 202 may not include a property size in the advertisement. The real estate property data added to the dataset may include “N/A” or null for this data type.

After cleaning and formatting the address, the data staging process 200 may store the address in the second format in the dataset data store 230. The information for the real estate property may comprise, for example, address 232 (“123 Main Street”), building floor 233 (“first building floor”), lease term 234 (“twelve months”), and property size 235 (“N/A”).

FIG. 3 is an illustrative list of features 300, according to various aspects of the present disclosure. The features may be stored as different columns in the dataset data store, and where each row corresponds to a single lease. As described above, various information may be stored in the dataset, including lease commencement date (“LCD”), logarithmic value of the leasable square footage (“logLSF”), lease term, floor number bucket, lease type, building class, borough, space type post, year renovated bucket, year built bucket, year signed, month signed, contract rate (e.g., logarithmic conversion value of the contract rate), YoY inflation, velocity of YoY inflation (by quarter), velocity of YoY inflation (by year), acceleration of YoY inflation (by quarter), acceleration of YoY inflation (by year), ten-year interest rate, velocity of QoQ ten-year interest rate, velocity of YoY one-year interest rate, acceleration of QoQ ten-year interest rate, acceleration of YoY ten-year interest rate, is landmark, is historic, minimum distance (e.g., to an amenity or other location), facility type, occupancy, velocity of occupancy (by year), delta floor price (e.g., the difference between lease prices across different floors in the real estate property), quarter (e.g., the quarter that the lease was signed, Q1, Q2, etc.), cap rate, restaurant flag, café flag, gym flag, bar flag, amenity density, minimum distance to bike share, number of bike shares within one mile, LEED level, LEED points per 50K SqFt, LEED age (in years), latest Energy Star Score, Energy Star Score building age (at the time of the last certification date), Energy Star Score per 50K SqFt, hotel count, hotel density per mile, office SqFt percent, logarithmic value of the YoY lease price percent change by zip code, year (e.g., the year that the lease was signed), actual contract rate, and predicted contract rate.

FIG. 4 illustrates a set of windows that comprise data backward in time from a particular date, according to various aspects of the present disclosure. In these examples, lease dates 402, 412, and 422 and subsets of the dataset are shown along three timelines 400, 410, and 420 for illustrative purposes. The subsets of the dataset are shown as substantially equal time windows 404, 414, 416, 424, 426, and 428 associated with each particular date 402, 412, and 422, respectively. The data in the subsets of the dataset may include any data identified herein without diverting from the present disclosure.

In a first example timeline 400, the particular date 402 in the dataset corresponds to a lease date. The time window 404 associated with the particular date 402 identifies data that correspond to dates backward in time from the particular date 402. In a second example timeline 410, the particular date 412 in the dataset corresponds to a lease date. Two time windows 414 and 416 associated with the particular date 412 identify data that correspond to dates backward in time from the particular date 412. In a third example timeline 420, the particular date 422 in the dataset corresponds to a lease date. Three time windows 424, 426, and 428 associated with the particular date 422 identify data that correspond to dates backward in time from the particular date 422.

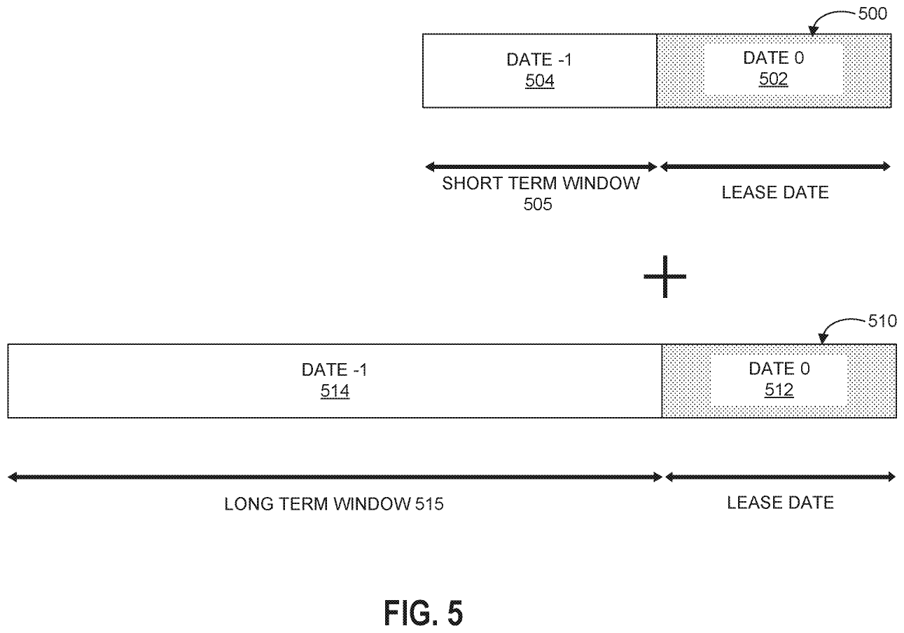

FIG. 5 illustrates a short term window and a long term window that comprise data backward in time from a particular date, according to various aspects of the present disclosure. In this example, lease dates 502 and 512 and subsets of the datasets 504 and 514 are shown along two timelines 500 and 510 for illustrative purposes. The subsets of the dataset are shown as two non-equal time windows, including a short term time window 505 and a long term time window 515 associated with each particular date 502 and 512, respectively. The data in the subsets of the dataset may include any data identified herein without diverting from the present disclosure.

In a first example timeline 500, the particular date 502 in the dataset corresponds to a lease date. The short term time window 505 associated with the particular date 502 identifies data that corresponds to dates backward in time from the particular date 502. In a second example timeline 510, the particular date 512 in the dataset corresponds to a lease date. The long term time window 515 associated with the particular date 512 identifies data with dates backward in time from the particular date 512. In some examples, the long term time window 515 comprises more dates and data than the data associated with the short term time window 505.

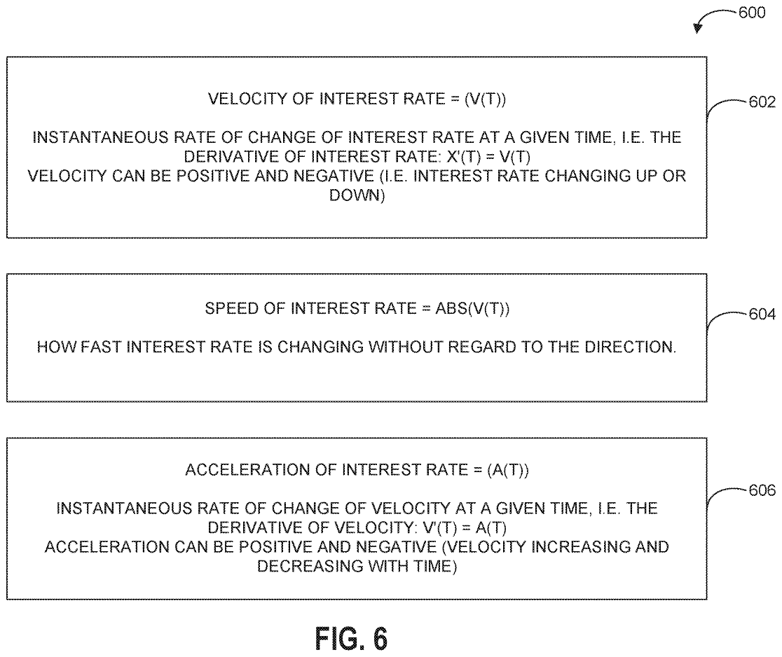

FIG. 6 illustrates a portion of a derivative process 600 to generate velocity, speed, and acceleration, according to various aspects of the present disclosure. In this example, the interest rate is determined for a real estate property for a particular date in a dataset during a time window. As illustrated herein, the time window may correspond to a subset of data in the dataset and may be a long term window or a short term window that comprises data that is backward in time from the particular date.

Various derivatives of the interest rate may be determined. For example, a first derivative 602 of the interest rate may be determined for a velocity of the interest rate or v(t) (velocity with respect to time). This value may correspond to an instantaneous rate of change of the interest rate at a given time, i.e., the derivative of interest rate: x′(t)=v(t). Velocity may be positive or negative (i.e., interest rate is changing up or down). Similarly, a speed 604 of an interest rate may be determined as the absolute value of the velocity and corresponds to the magnitude of the velocity, i.e., how fast the interest rate is changing without regard to the direction.

A second derivative may be determined of the interest rate. For example, a second derivative 606 of the interest rate may be determined for an acceleration of the interest rate or a (t) (acceleration with respect to time). This value may correspond to an instantaneous rate of change of the velocity at a given time, i.e., the derivative of the velocity. The acceleration may be positive or negative, i.e., velocity increasing or decreasing with time.

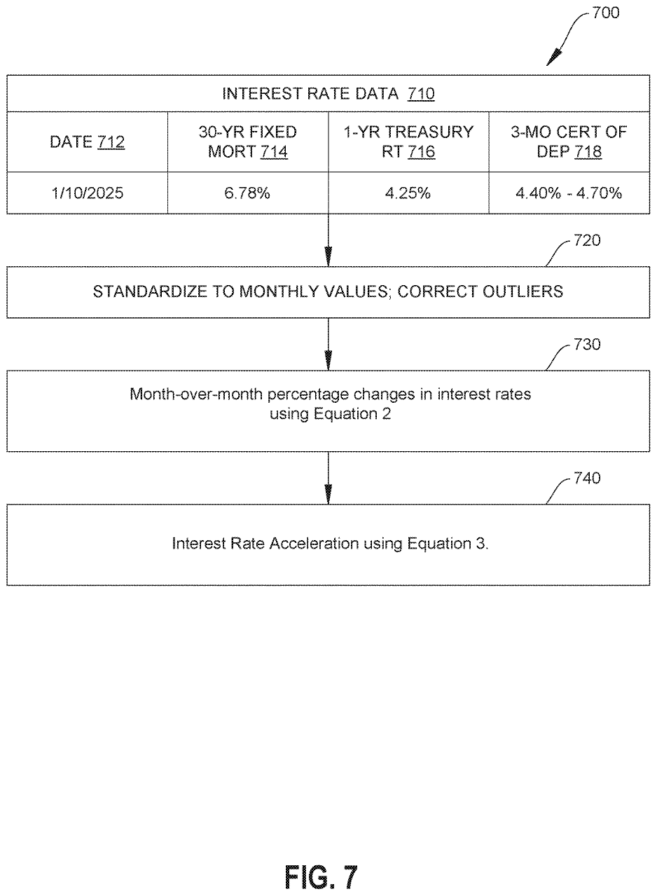

FIG. 7 illustrates a process 700 associated with a price value or interest rate, according to various aspects of the present disclosure. For example, the price value or interest rate data 710 may be received from a data source. The data 710 may include, for example, a date 712 corresponding with the date that the price value or interest rate was active and/or published, a first interest rate 714 (e.g., thirty-year fixed mortgage rate), a second interest rate 716 (e.g., a one-year treasury rate), and a third interest rate 718 (e.g., a three-month certificate of deposit rate).

The price value or interest rate data 710 may be adjusted 720. For example, the interest rate data may be cleaned and formatted by standardizing the interest rates to a monthly frequency and correcting any outliers or anomalies (i.e., deleting or removing).

The interest rate velocity 730 may be determined. For example, the velocity of the interest rate (e.g., month-over-month percentage change) may be computed by Equation 2.

The interest rate acceleration 740 may be determined. For example, the acceleration of the interest rate, i.e., change in velocity of the interest rate, may be computed by Equation 3.

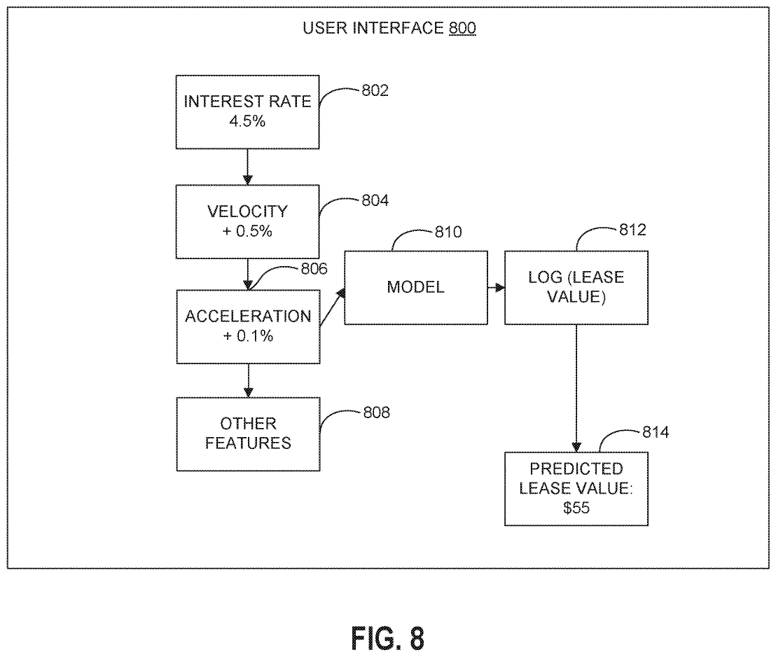

FIG. 8 illustrates a user interface 800 at a terminal, according to various aspects of the present disclosure. In this example, various information may be provided to a terminal and displayed on a user interface 800.

At block 802, an interest rate value may be determined. As an illustrative example, the interest rate may be published as “4.5%” on a particular date (e.g., the historical date when the lease was signed). The interest rate data for that particular date may be received from central banks, financial institutions, and market platforms. The interest rate data may be cleaned and formatted by standardizing the interest rates to a monthly frequency and correcting any outliers or anomalies (i.e., deleting or removing). The data may include, for example, a date corresponding with the date that the price value or interest rate was active or published, a first interest rate (e.g., thirty-year fixed mortgage rate), a second interest rate (e.g., a one-year treasury rate), and a third interest rate (e.g., a three-month certificate of deposit rate).

At block 804, an interest rate velocity may be determined. For example, a derivative process may be initiated on a window of data corresponding to a subset of the dataset backward in time from the particular date. The derivative process may generate a velocity value of the interest rate (e.g., month-over-month percentage changes in interest rates) by Equation 2.

At block 806, an interest rate acceleration may be determined. For example, the derivative process may use the window of data corresponding to a subset of the dataset backward in time from the particular date. The derivative process may generate an acceleration of the interest rate by Equation 3.

At block 808, other features may be determined. Some illustrative features are discussed throughout the present disclosure and as shown in FIG. 3.

At block 810, the values associated with the interest rate may be provided to a model. Various models may be implemented without diverting from the present disclosure. For example, an Extreme Gradient Boosting (XGBoost) model may be implemented. The XGBoost model may build a sequence of decision trees and, at each iteration, the model minimizes a regularized loss function that combines training error with a penalty for complexity. In some examples, a model may be implemented using a derivative value(s) alone, e.g., velocity or acceleration of interest rate and/or velocity or acceleration of inflation rate. In some examples, a model may be implemented using a scalar value(s), e.g., interest rate and/or inflation rate, and a derivative value(s), e.g., velocity or acceleration of interest rate and/or velocity or acceleration of inflation rate.

In another example, a time series model may be implemented with a time series cross validation. The time series model may be trained on a historical window of data to predict a price value at a particular date (e.g., train the model on data from 2010 to 2015 and predict for 2016). The window of data may be expanded, e.g., the training set may be expanded to include 2016 and predict for 2017. The increasing window size may be expanded until a present date is covered, e.g., keep adding data to the window of data until the data up to 2025 is covered. This method may preserve the temporal order of the data and prevent the leakage of future information into the training set.

At block 812, a predicted price value may be determined from the model and provided to a logarithmic calculation. For example, the price value may correspond to a lease value of the real estate property. The log of the lease may be stored with the dataset data store.

At block 814, a predicted lease value may be provided to the user interface 800. As an illustrative example, the predicted value may be published as “$55” on a particular date (e.g., the price per SqFt of the real estate property).

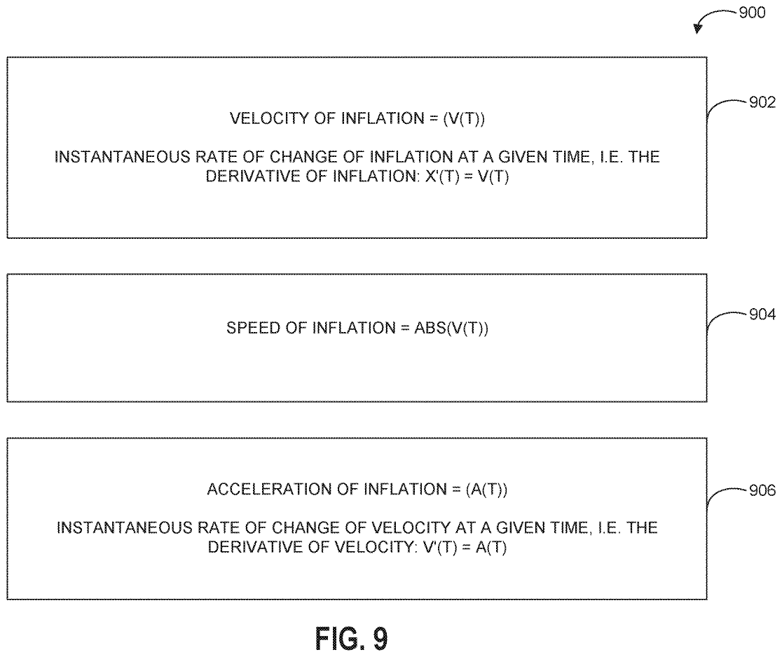

FIG. 9 illustrates a derivative process 900 to generate velocity, speed, and acceleration, according to various aspects of the present disclosure. In this example, the inflation rate is determined for a real estate property for a particular date in a dataset during a time window. As illustrated herein, the time window may correspond to a subset of data in the dataset and may be a long term window or a short term window that comprises data that is backward in time from the particular date.

Various derivatives of the inflation rate may be determined. For example, a first derivative 902 of the inflation rate may be determined for a velocity of the inflation rate or v(t) (velocity with respect to time) (e.g., a first-order derivative). This value may correspond to an instantaneous rate of change of inflation rate at a given time, i.e. the derivative of inflation rate: x′(t)=v(t). Velocity may be positive and negative (i.e. inflation rate is changing up or down). Similarly, a speed 904 of an inflation rate may be determined as the absolute value of the velocity and corresponds to the magnitude of the velocity (i.e. how fast the inflation rate is changing without regard to the direction).

A second derivative may be determined of the inflation rate. For example, a second derivative 906 of the inflation rate may be determined for an acceleration of the inflation rate or a (t) (acceleration with respect to time) (e.g., a second-order derivative). This value may correspond to an instantaneous rate of change of the velocity at a given time, i.e. the derivative of the velocity. The acceleration may be positive and negative (i.e. velocity increasing and decreasing with time).

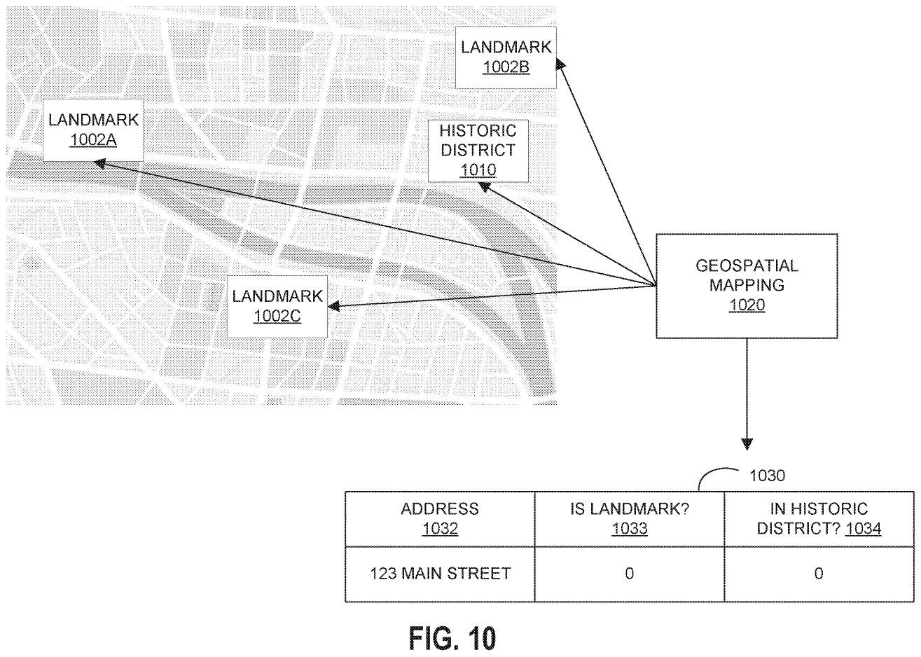

FIG. 10 illustrates geospatial mapping associated with a dataset, according to various aspects of the present disclosure. In this example, various real estate properties are provided in a geographic area, including a set of landmarks (e.g., first landmark 1002A, second landmark 1002B, and third landmark 1002C) and a historic district 1010 with historic real estate properties.

The locations of the set of landmarks and historic district may be provided to a geospatial mapping process 1020. The geospatial mapping process 1020 may combine geographic or location data (e.g., latitude and longitude, GPS coordinate, satellite imagery, etc.) with attribute data (e.g., whether the building is a landmark or historic district, etc.). The geographic or location data may be cleaned and formatted by standardizing coordinates, as described herein.

In some examples, the real estate property may be matched by an address in the dataset data store and an address of the landmark or historic district in a National Register of Historic Places. In other examples, a latitude and longitude of the real estate property may be matched to a latitude and longitude of the landmark or historic district in a National Register of Historic Places.

In some examples, a dataset 1030 may include the location or address 1032 of the real estate property and whether the real estate property is a landmark 1033 or historic district 1034. For example, the dataset may identify whether the real estate property is a landmark or historic district and store the determination as a binary value (0=not present, 1=present).

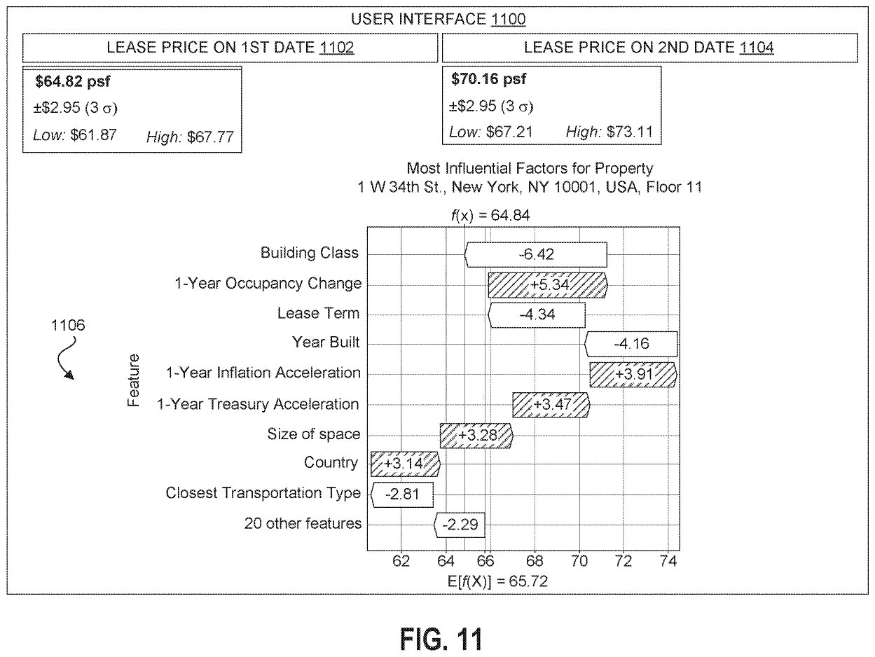

FIG. 11 illustrates a user interface 1100 at a terminal, according to various aspects of the present disclosure. In some examples, a predicted lease price of the real estate property may be provided to the user interface 1100, including a lease price on a first date 1102 and a lease price on a second date 1104.

Various features 1106 may also be provided. In this example, the features 1106 may include the building class, YoY occupancy change, lease term, year built, YoY inflation acceleration, YoY interest rate (treasury) acceleration, size of space, county, closest transportation type, and other features.

In some examples, the user interface 1100 may enable sliding scales of the features 1106 to identify the movement of and difference in the lease prices on a particular date. For example, when the year built feature is reduced by sliding the tool on the user interface 1100, the lease price of the real estate property may also decline. This display information may help illustrate the direct correlation between a single feature and the predicted lease price on the particular date. Stated another way, the features 1106 which are the most important for the final price in terms of contributions and data that is driving the price value may be illustrated.

In some examples, the user interface 1100 may be generated using HyperText Markup Language (HTML) or other web-based language to display data relevant to the determination of the price value of the real estate property. The data may include any information discussed throughout without diverting from the present disclosure.

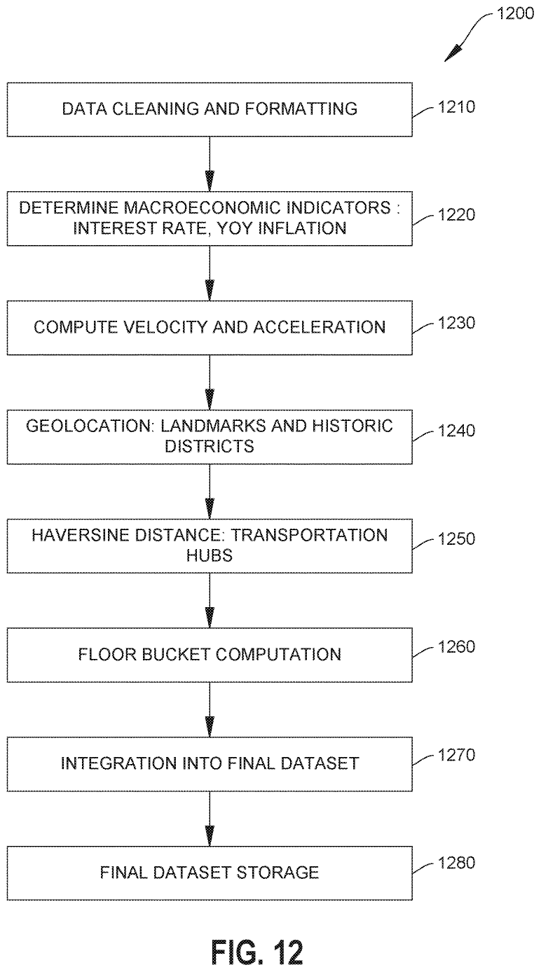

FIG. 12 is an example process 1200 of reducing leakage in a dataset, according to various aspects of the present disclosure. The process 1200 may be implemented by systems, devices, or terminals described throughout the present disclosure, including the dataset generation system 102 of FIG. 1.

At block 1210, data cleaning and formatting may be implemented. For example, as described in FIG. 1, the system 102 may receive and clean various types of data and store the data in dataset data store. The data may include, for example, occupancy data, CPI data, interest rate data, and geolocation data. Occupancy data may be cleaned and formatted by receiving an occupancy value in a date range and standardizing the occupancy data to a monthly frequency. The missing values in the occupancy data may be interpolated. CPI data may be cleaned and formatted by seasonally adjusting and standardizing the CPI data to a chosen base period. Interest rate data may be cleaned and formatted by standardizing the interest rates to a monthly frequency and correcting any outliers or anomalies (i.e., deleting or removing). Geolocation data may be cleaned and formatted by standardizing latitude and longitude coordinates.

At block 1220, macroeconomic indicators including the interest rate and inflation rate may be determined. For example, the system 102 may determine a particular time range for the data in the dataset that would have been known at the time the lease was created or signed. This determination may help temporally align or match the data with the particular date of the signed lease.

At block 1230, velocity and acceleration of the interest rate and inflation rate may be computed by the system 102. For example, the velocity and acceleration may correspond to calculating a derivative of the value (e.g., interest rate or inflation rate).

At block 1240, geolocation data, including whether the real estate property is a landmark or in a historic district, may be determined. For example, the address in a National Register of Historic Places may identify properties as landmarks or historic buildings or districts. The system 102 may match an address of a particular real estate property to the address in the National Register of Historic Places.

At block 1250, a Haversine distance between the real estate property and a transportation hub may be computed. For example, the system 102 may calculate accurate distances from the real estate property to other locations, like the transportation hubs or other amenities.

At block 1260, a floor bucket computation may be implemented. For example, the system 102 may first determine a baseline group of floors (e.g., floors Ground through 10) as a first floor bucket. The system 102 may assign each floor's membership in either the baseline group or a higher-floor group of units (e.g., a “bucket” of floors 20 and above). The system 102 may compute an average lease price metric (e.g., log (contract rate)) for each floor bucket/group, by location (e.g., zip code) and time period (e.g., quarter). The baseline group's average rate may be subtracted from the high-floor group's average rate.

At block 1270, the data may be integrated into a final dataset. For example, the system 102 may store the dataset with the derivative or temporal alignment using the equations described herein (e.g., derivatives of values, quarterly/QoQ differences in velocity and acceleration, annual/YoY differences in velocity and acceleration, etc.).

At block 1280, the process may store the final dataset in a dataset data store. Further processing and analysis may be implemented on the final dataset.

It should be noted that the terms “optimize,” “optimal” and the like as used herein may be used to mean making or achieving performance as effective or perfect as possible. However, as one of ordinary skill in the art will recognize, perfection may not always be achieved. Accordingly, these terms may also encompass making or achieving performance as good or effective as possible or practical under the given circumstances, or making or achieving performance better than that which may be achieved with other settings or parameters.

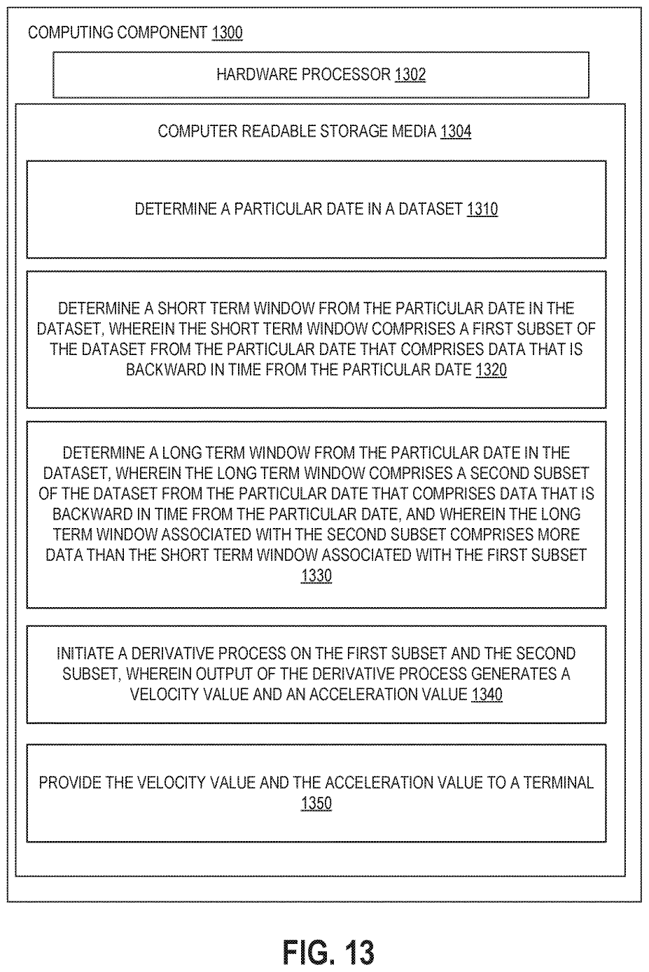

FIG. 13 is an example computing component 1300 that may be used to reduce data leakage in datasets in accordance with various embodiments of the present disclosure. Referring to FIG. 13, computing component 1300 may be, for example, a server computer (e.g., a server computing device), a controller, or any other similar computing component capable of processing data. In the example implementation of FIG. 13, computing component 1300 includes hardware processor 1302 and computer readable memory storage medium 1304.

Hardware processor 1302 may be one or more central processing units (CPUs), semiconductor-based microprocessors, and/or other hardware devices suitable for retrieval and execution of instructions stored in computer readable memory storage medium 1304. Hardware processor 1302 may fetch, decode, and execute instructions, such as instructions 1310, 1320, 1330, 1340, and 1350, to control processes or operations for determining derivative data and reducing data leakage in datasets in accordance with systems and methods disclosed herein. As an alternative or in addition to retrieving and executing instructions, hardware processor 1302 may include one or more electronic circuits that include electronic components for performing the functionality of one or more instructions, such as an FPGA, ASIC, or other electronic circuits.

A computer readable memory storage medium, such as computer readable memory storage medium 1304, may be any electronic, magnetic, optical, or other physical storage device that contains or stores executable instructions. Thus, machine-readable storage medium 1304 may be, for example, RAM, NVRAM, EEPROM, a storage device, an optical disc, and the like. In some embodiments, computer readable memory storage medium 1304 may be a non-transitory computer readable memory storage medium, where the term “non-transitory” does not encompass transitory propagating signals. As described in detail below, computer readable memory storage medium 1304 may be encoded with executable instructions, for example, instructions 1310, 1320, 1330, 1340 and 1350.

Hardware processor 1302 may execute instruction 1310 to determine a particular date in a dataset. For example, the particular date may be associated with a price value of a real estate property.

Hardware processor 1302 may execute instruction 1320 to determine a short term window from the date in the dataset. In some examples, the short term window comprises a first subset of the dataset from the particular date that comprises data that is backward in time from the particular date.

Hardware processor 1302 may execute instruction 1330 to determine a long term window from the particular date in the dataset. For example, the long term window comprises a second subset of the dataset from the particular date that comprises data that is backward in time from the particular date. The long term window associated with the second subset may comprise more data than the short term window associated with the first subset.

Hardware processor 1302 may execute instruction 1340 to initiate a derivative process on the first subset and the second subset. In some examples, the output of the derivative process generates a velocity value and an acceleration value. The velocity value may be determined by computing a first-order finite difference over each of the first subset and the second subset. The acceleration value may be determined by computing a second-order finite difference.

Hardware processor 1302 may execute instruction 1350 to provide the velocity value and the acceleration value to a terminal.

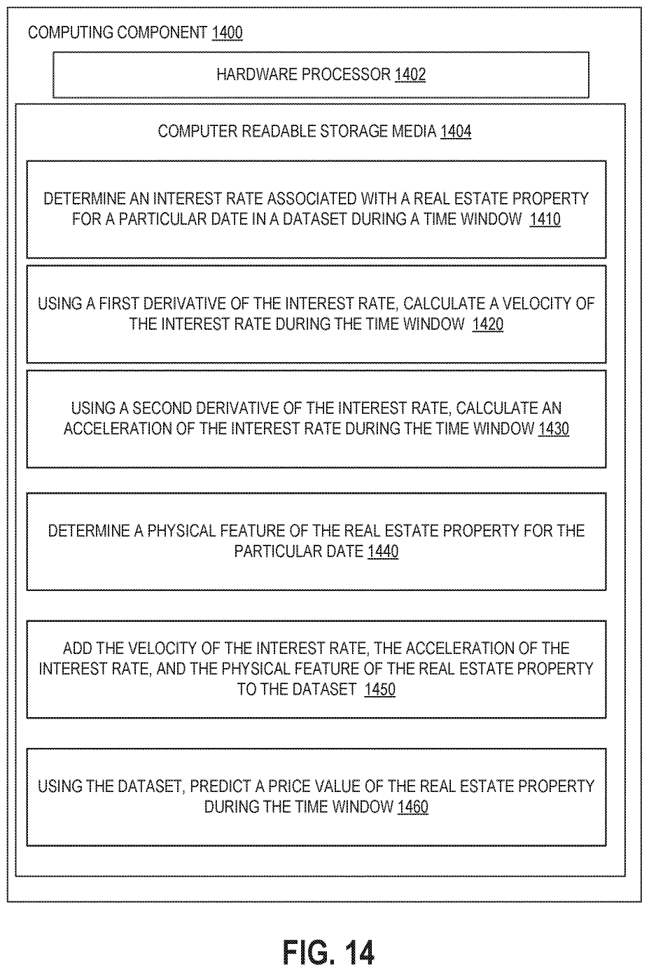

FIG. 14 is an example computing component 1400 that may be used to reduce data leakage in datasets in accordance with various embodiments of the present disclosure. Referring now to FIG. 14, computing component 1400 may be, for example, a server computer (e.g., a server computing device), a controller, or any other similar computing component capable of processing data. In the example implementation of FIG. 14, computing component 1400 includes hardware processor 1402 and computer readable memory storage medium 1404.

Hardware processor 1402 may be one or more central processing units (CPUs), semiconductor-based microprocessors, and/or other hardware devices suitable for retrieval and execution of instructions stored in computer readable memory storage medium 1404. Hardware processor 1402 may fetch, decode, and execute instructions, such as instructions 1410, 1420, 1430, 1440, 1450, and 1460, to control processes or operations for determining derivative data and reducing data leakage in datasets using systems and methods disclosed herein. As an alternative or in addition to retrieving and executing instructions, hardware processor 1402 may include one or more electronic circuits that include electronic components for performing the functionality of one or more instructions, such as a FPGA, ASIC, or other electronic circuits.

A computer readable memory storage medium, such as computer readable memory storage medium 1404, may be any electronic, magnetic, optical, or other physical storage device that contains or stores executable instructions. Thus, machine-readable storage medium 1404 may be, for example, RAM, NVRAM, EEPROM, a storage device, an optical disc, and the like. In some embodiments, computer readable memory storage medium 1404 may be a non-transitory computer readable memory storage medium, where the term “non-transitory” does not encompass transitory propagating signals. As described in detail below, computer readable memory storage medium 1404 may be encoded with executable instructions, for example, instructions 1410, 1420, 1430, 1440, 1450, and 1460.

Hardware processor 1402 may execute instruction 1410 to determine an interest rate associated with a real estate property for a particular date in a dataset during a time window.

Hardware processor 1402 may execute instruction 1420 to calculate a velocity of the interest rate during the time window using a first derivative of the interest rate.

Hardware processor 1402 may execute instruction 1430 to calculate an acceleration of the interest rate during the time window using a second derivative of the interest rate.

Hardware processor 1402 may execute instruction 1440 to determine a physical feature of the real estate property for the particular date.

Hardware processor 1402 may execute instruction 1450 to add the velocity of the interest rate, the acceleration of the interest rate, and the physical feature of the real estate property to the dataset.

Hardware processor 1402 may execute instruction 1460 to predict a price value of the real estate property during the time window using the dataset.

An exemplary implementation of the present disclosure that illustrates the advantages of determining a lease price accurately in accordance with aspects of the present disclosure is described below. Although the example is for determining lease price of a commercial real estate property, it is to be understood that the features of the present disclosure may be similarly implemented and adopted to accurately determine lease or sale price of any type of real estate property. As discussed below, based on experimentation with a model as described in Section 1, models as described in Sections 2 and 3 in accordance with the present disclosure were developed and recognized.

### Experimental Setup and Results

### 1. Baseline Setup

### 1.1 Overview of the Dataset

A model was trained on a dataset consisting of 29,318 individual office lease transactions across the five boroughs of New York City. Each row represented one executed lease with characteristics of the building and the lease, for a total of 12 features.

### 1.2 Feature Engineering and Groupings

The final feature space included 11 variables, grouped below for clarity.

### 1.2.1 Table 1. Lease Characteristics

TABLE 1
logLSF: Natural logarithm of leasable square footage for variance
stabilization.
LeaseTerm: Contracted lease duration expressed in months.
LeaseType: Classification of financial structure:
Full Gross/Full Service
Modified Gross
NNN (Triple Net)
SpaceTypePost: Normalized space category: Office, Medical Office, or
Governmental.
FloorNumberBucket: Floor-grouping rules:
Ground floor = GRND
Floors 1-19 remain unchanged
Floors 20-30 grouped into 20-30
Floors 30-40 grouped into 30-40
Floors 40-50 grouped into 40-50
Floors above 50 grouped into >50
1.2.2 Building Characteristics
BuildingClass: Office class designation (A/B/C).
YearBuiltBucket: Grouped construction vintage:
<1950, 1950-1970, 1970-1980, 1980-1990, 1990-2000, 2000-2010,
>2020, Unknown
YearRenovatedBucket: Grouped renovation year using the same ranges as
above, plus:
Not Renovated
1.2.3 Temporal Features
YearSigned: Year in which the lease was executed.
MonthSigned: Month of lease execution.
Quarter: Calendar quarter corresponding to lease signing.
1.3. Model Training Procedure
Hyperparameter Sweep (288 models)
A total of 60 configurations were tested using the following parameter
ranges:
n_estimators: 100, 500
learning_rate: 0.05, 0.1, 0.25
max_depth: 11, 30, None
gamma: 0.1, 1

Validation was performed by training the model with data from 2010 to 2015, then validating using 2016 data, then adding 2016 data to the training data and validating using 2017 data, and so on until 2023, where 2024 data is used as the blind test set. Overall, 288 models were trained.

### Time-Series Results

### 1.4. Model Performance Summary

### 1.4.1 Summary Metrics

Table 2 summarizes the time-series results over the different folds

### Cross-Validation Splits in Vertical Layout

TABLE 2

| Training | Validation | Train MAPE | Validation |
|---|---|---|---|
| Window | Year | (%) | MAPE(%) |
| 2010-2015 | 2016 | 21.78 | 24.25 |
| 2010-2016 | 2017 | 20.87 | 23.27 |
| 2010-2017 | 2018 | 21.65 | 23.48 |
| 2010-2018 | 2019 | 19.94 | 22.15 |
| 2010-2019 | 2020 | 22.41 | 25.23 |
| 2010-2020 | 2021 | 21.88 | 26.87 |
| 2010-2021 | 2022 | 22.33 | 24.78 |
| 2010-2022 | 2023 | 21.77 | 23.48 |

After the best-performing model (using MAPE values above) was determined, a final training was performed to determine the results for the entire training set. Table 3 summarizes the final model's predictive performance based on cross-validation results from the hyperparameter sweep.

### Table 3. Model Performance Metrics

TABLE 3

| Metric | Value | Description |
|---|---|---|
| MAPE | 21.49 | Mean Absolute Percentage Error |
| MAPE Std. Dev. | 4.88 | Variability in MAPE across runs |

### 1.4.2 Interpretation of Metrics

### Mean Absolute Percentage Error (MAPE).

MAPE measures the average percentage difference between predicted and actual contract lease prices:

$$MAPE = \frac{1}{n} \sum \vert \frac{Actual - Predicted}{Actual} \vert \times 100$$

A MAPE of 21.49% indicates that, on average, the model's predictions deviate from true market lease prices by approximately 21.49%. Model “accuracy” is expressed as:

Accuracy=100−MAPE=78.51%

This value reflects the mean closeness of predictions to actual lease prices on a percentage basis.

### MAPE Standard Deviation.

The standard deviation of 4.88 indicates that the model's error is consistent and does not fluctuate significantly across the evaluated runs. Lower variability implies stable performance and reliable generalization.

### Combined Interpretation.

Together, these metrics demonstrate that the model at this stage:
May predict, with about 80% accuracy, the price of a lease with building and lease characteristics such as illustrated in Table 1, and
Predicts prices with stability and that are reproducible across time, however, with a significant increase in error, i.e., decrease in accuracy, during the COVID time period, e.g., about 2020-2023, and the subsequent interest rate period.

In view of these results, further experimentation was conducted using additional variables, including macroeconomic features and temporal variables, to increase performance.

### 2. Macro-Derived Features Setup

### 2.1. Overview of the Dataset

Review of Section 1 model performance revealed that features significant to accurate price valuation likely were not identified and incorporated into training data.

It was further determined and recognized that a significant portion of what was missing from the training of the model of Section 1 was an understanding of the macroeconomic setting and environment. Given that real estate transactions are correlated to the economic cycle, it was determined to add a set of macroeconomic features to the training of the model. The model of Section 2 was trained on a dataset consisting of 29,318 individual office lease transactions across the five boroughs of New York City. Each row of the dataset represents one executed lease enriched with a total of 21 engineered features, where the new additions to the dataset were based on derived features from Interest Rate, Inflation Rate and CPI. Additional features were incorporated into a training dataset to characterize both short term and long term trends in macroeconomic indicators, based on concepts analogous to technical indicators. It was determined that 1-year velocity and acceleration and 3-month velocity and acceleration of the macroeconomic indicators may be used to represent short term and long term momentum of the economic cycle.

The selected macroeconomic indicators—including inflation rates, interest rates, and occupancy metrics—were aligned to the lease signing date (YearSigned, MonthSigned, Quarter). This temporal alignment ensures that the model only incorporates information that existed at the time the lease was executed, thereby preventing lookahead bias and improving predictive integrity.

### 2.2. Feature Engineering and Groupings

### 2.2.1 Table 4. Lease Characteristics

TABLE 4
logLSF: Natural logarithm of leasable square footage for variance
stabilization.
LeaseTerm: Contracted lease duration expressed in months.
LeaseType: Classification of financial structure:
Full Gross/Full Service
Modified Gross
NNN (Triple Net)
SpaceTypePost: Normalized space category: Office, Medical Office, or
Governmental.
FloorNumberBucket: Floor-grouping rules:
Ground floor = GRND
Floors 1-19 remain unchanged
Floors 20-30 grouped into 20-30
Floors 30-40 grouped into 30-40
Floors 40-50 grouped into 40-50
Floors above 50 grouped into >50
2.2.2 Building Characteristics
BuildingClass: Office class designation (A/B/C).
YearBuiltBucket: Grouped construction vintage:
<1950, 1950-1970, 1970-1980, 1980-1990, 1990-2000, 2000-2010,
2010-2020, >2020, Unknown
YearRenovatedBucket: Grouped renovation year using the same ranges as
above, plus:
Not Renovated
2.2.3 Temporal Features
YearSigned: Year in which the lease was executed.
MonthSigned: Month of lease execution.
Quarter: Calendar quarter corresponding to lease signing.
2.2.4 Macroeconomic Indicators (Aligned to Signing Date)-
(See Equations 2, 3, 4 and 5 above for determination of velocity and
acceleration)
YoY_Inflation: Year-over-year inflation rate.
velocity_3m_YoY_Inflation: Three-month directional change.
velocity_1y_YoY_Inflation: One-year directional change.
acceleration_3m_YoY_Inflation: Rate of change of the short-term
velocity.
acceleration_1y_YoY_Inflation: Rate of change of the annual velocity.
10YrIR: Level of the 10-Year Treasury rate.
velocity_3m_10YrIR: Three-month directional change.
velocity_1y_10YrIR: One-year directional change.
acceleration_3m_10YrIR: Rate-of-change of the short-term velocity.
acceleration_1y_10YrIR: Rate-of-change of the long-term velocity.
2.3 Expected Incremental Impact
Incremental contribution of macroeconomic level and dynamic
indicators.

Relative to the Section 1 model prediction, which incorporates only structural lease attributes, building characteristics, and temporal identifiers, the addition of both static and dynamic macroeconomic features in the Section 2 model, as discussed below, yielded a measurable improvement in predictive accuracy. This enhanced feature family provides information not captured by the Section 1 model and contributes incrementally in the following ways:

Macroeconomic level indicators (YoY_Inflation and 10YrIR) introduce the prevailing inflation and interest-rate environment at the time of lease execution, enabling the model to adjust for systematic shifts in nominal lease price levels across economic cycles.

Short- and long-horizon velocity measures for inflation and interest rates supply directional information regarding the trajectory of macroeconomic series, allowing the model to differentiate leases that are identical in structural characteristics but signed under materially different economic trends.

Acceleration measures capture inflection points in macroeconomic series, providing sensitivity to periods of rapidly changing monetary or inflationary conditions that are not identifiable through one or more of level, e.g., interest rate and/or inflation rate, and velocity.

The combined inclusion of level, velocity and acceleration indicators advantageously enables the model to incorporate regime awareness, for example, for real estate lease prices, thereby improving the model's ability to represent cross-sectional and temporal variation in lease prices that arise from fluctuations in different macroeconomic conditions.

### 2.4. Model Training Procedure

Hyperparameter Sweep (972 models)

A total of 60 configurations were tested using the following parameter ranges shown in Table 5:

TABLE 5

| Parameter | Min | Mid | Max |
|---|---|---|---|
| n_estimators | 100 | 500 | |
| learning_rate | 0.05 | 0.1 | 0.25 |
| max_depth | 11 | 30 | None |
| gamma | 0.1 | 1 | |
| colsample_bytree | 0.5 | 0.75 | 1 |

The Validation was done training the model with datasets from 2010 to 2015, then validating in 2016, then adding the 2016 dataset to the training dataset and validating on the 2017 dataset, and so on until 2023, where 2024 is used as the blind test set. Overall, about 972 models were trained.

### 2.5 Results Summary

Table 6 reports the cross-validation performance for this feature set which includes core characteristics and macroeconomic features. All experiments share identical temporal folds to ensure comparability across feature sets.

Table 6. Cross-Validation Splits for Feature Space Including Macroeconomics.

TABLE 6

| Training | Validation | Train MAPE | Validation MAPE |
|---|---|---|---|
| Window | Year | (%) | (%) |
| 2010-2015 | 2016 | 8.69 | 8.13 |
| 2010-2016 | 2017 | 7.59 | 10.21 |
| 2010-2017 | 2018 | 7.75 | 10.25 |
| 2010-2018 | 2019 | 7.90 | 11.53 |
| 2010-2019 | 2020 | 8.3 | 10.23 |
| 2010-2020 | 2021 | 7.42 | 8.34 |
| 2010-2021 | 2022 | 7.52 | 8.52 |
| 2010-2022 | 2023 | 8.52 | 10.61 |

After the best model is determined as a final model, a final training is performed to determine the results for the whole training set. Table 7 summarizes the final model's predictive performance based on cross-validation results from a hyperparameter sweep.

### Table 7. Model Performance Metrics

TABLE 7

| Metric | Value | Description |
|---|---|---|
| MAPE | 9.73 | Mean Absolute Percentage Error |
| MAPE Std. Dev. | 1.16 | Variability in MAPE across runs |

### 2.3.2 Interpretation of Metrics

### Mean Absolute Percentage Error (MAPE).

MAPE measures the average percentage difference between predicted and actual contract lease prices:

$$MAPE = \frac{1}{n} \sum \vert \frac{Actual - Predicted}{Actual} \vert \times 100$$

A MAPE of 9.73% indicates that, on average, the model's predictions deviate from true market lease price by approximately 9.73%. Model “accuracy” is expressed as:

Accuracy=100−MAPE=90.27%

This value reflects the mean closeness of predictions to actual lease prices on a percentage basis.

### MAPE Standard Deviation.

The standard deviation of 1.16 indicates that the model's error is consistent and does not fluctuate significantly across the evaluated runs. Lower variability implies stable performance and reliable generalization.

### Combined Interpretation.

Together, these metrics demonstrate that the model is:
Able to predict with about 90% accuracy the price of a lease with building and lease characteristics, with the addition of economic cycle features, which include derived macroeconomic features; and
Stable and reproducible across time, where the derived features add stability and help the model recognize and adjust for the business cycle and the fluctuations during the COVID time period.

Advantageously, the model may predict lease prices with at least about 90% accuracy. The model was further enhanced, based on experimentation to replicate the behavior of human brokers, with the addition of features that focus on the broker's know-how. It was found that the model may predict lease price with building and lease characteristics such as illustrated in Table 4, and the addition of economic cycle features, with about 90% accuracy.

It was observed, through experimentation, that adding only the Interest Rate and YoY Inflation features provided on average about a 3% increase in accuracy, while adding the level, the velocity, and the acceleration provided about an additional 7% increase in accuracy.

Further, it was observed that the model is stable and reproducible across time, where the derived features add stability and help the model recognize and understand the business cycle and the fluctuations during the COVID period.

Stated another way, training the model with a combination of short-term and long-term velocity and acceleration features advantageously provided the non-linearity needed to represent different changes in the economic cycle. For example, 3-month velocity features were significant features for obtaining stable and reproducible model performance for 2010-2018, while long-term velocity and acceleration combined with short-term velocity were significant features that improved model performance during the COVID time period and the subsequent dove and hawkish interest rate environment following the COVID time period starting in about 2022.

### 3. Final Features Setup

### 3.1. Overview of the Dataset

A model was trained on a dataset consisting of 29,318 individual office lease transactions across the five boroughs of New York City. Each row represents one executed lease enriched with a total of 47 engineered features spanning physical building characteristics, lease structure, macroeconomic context, submarket fundamentals, sustainability measures, amenity availability, transportation access, and temporal identifiers.

Various macroeconomic indicators-including inflation rates, interest rates, and occupancy metrics-were strictly aligned to the lease signing date (YearSigned, MonthSigned, Quarter). This temporal alignment ensures that the model only incorporates information that existed at the time the lease was executed, thereby preventing lookahead bias and improving predictive integrity.

### 3.2. Feature Engineering and Groupings

The final feature space consists of 47 variables, grouped below for clarity, in Table 8.

### 3.2.1 Lease Characteristics

TABLE 8
logLSF: Natural logarithm of leasable square footage for variance
stabilization.
LeaseTerm: Contracted lease duration expressed in months.
LeaseType: Classification of financial structure:
Full Gross/Full Service
Modified Gross
NNN (Triple Net)
SpaceTypePost: Normalized space category: Office, Medical Office, or
Governmental.
FloorNumberBucket: Floor-grouping rules:
Ground floor = GRND
Floors 1-19 remain unchanged
Floors 20-30 grouped into 20-30
Floors 30-40 grouped into 30-40
Floors 40-50 grouped into 40-50
Floors above 50 grouped into >50
3.2.2 Building Characteristics
BuildingClass: Office class designation (A/B/C).
YearBuiltBucket: Grouped construction vintage:
<1950, 1950-1970, 1970-1980, 1980-1990, 1990-2000, 2000-2010,
2010-2020, >2020, Unknown
YearRenovatedBucket: Grouped renovation year using the same ranges as
above, plus:
Not Renovated
Is_Landmark: Indicates Landmark designation.
Is_Historic: Indicates presence within a historic district or similar
designation.
3.2.3 Temporal Features
YearSigned: Year in which the lease was executed.
MonthSigned: Month of lease execution.
Quarter: Calendar quarter corresponding to lease signing.
3.2.4 Macroeconomic Indicators-Inflation (Aligned to Signing Date)
YoY_Inflation: Year-over-year inflation rate.
velocity_3m_YoY_Inflation: Three-month directional change.
velocity_1y_YoY_Inflation: One-year directional change.
acceleration_3m_YoY_Inflation: Rate of change of the short-term velocity.
acceleration_1y_YoY_Inflation: Rate of change of the annual velocity.
3.2.5 Macroeconomic Indicators-Interest Rates (Aligned to Signing Date)
10YrIR: Level of the 10-Year Treasury rate.
velocity_3m_10YrIR: Three-month directional change.
velocity_1y_10YrIR: One-year directional change.
acceleration_3m_10YrIR: Rate-of-change of the short-term velocity.
acceleration_1y_10YrIR: Rate-of-change of the long-term velocity.
3.2.6 Submarket Fundamentals
Occupancy: Submarket occupancy at signing.
velocity_1y_Occupancy: Annual change in occupancy.
CapRate: Prevailing capitalization rate for the market.
YoY_LogLeasePctChange_ZIP: Year-over-year change in ZIP-level log
lease prices.
Borough: NYC borough of the property.
Delta_Floor_Price: Premium or discount associated with the leased floor
level.
3.2.7 Amenities
These variables reflect in-building amenities.
RestaurantFlag: Indicates whether the building contains a restaurant.
CafeFlag: Indicates the presence of a cafe.
BarFlag: Indicates the presence of a bar.
GymFlag: Indicates the presence of a fitness facility.
AmenityDensity: Density index where:
0 = Low, 1 = Medium, ≥2 = High
based on the count of amenity flags.
min_distance: Minimum distance to the nearest external facility.
facility_type: Category of nearest facility.
3.2.8 Transportation Accessibility
MinDistToBikeshare: Distance to nearest bike-share station.
NumBikeshare1mi: Count of bike-share stations within one mile.
3.2.9 Sustainability & Building Performance
LEEDLevel: Official LEED certification tier.
LEEDPtsPer50kSqft: LEED points normalized by:
Gross Floor Area/50,000
enabling comparison across buildings of different sizes.
LEEDAgeYears: Age of the LEED certification at signing.
EnergyStarScoreLatest: Most recent Energy Star score.
EnergyStarBldgAgeAtLastCert: Building age at last Energy Star .
certification
EnergyStarScorePer50kSqft: Energy Star score normalized using:
Gross Floor Area/50,000
3.2.10 Hospitality & Land Use Context
HotelCount: Number of hotels near the building.
HotelDensityPerMi2: Density of hotels normalized per square mile.
OfficeSqftPct: Percentage of surrounding area dedicated to office use.

### 3.3. Model Training Procedure

### Hyperparameter Sweep (2,000 Models)

A total of 2,000 configurations were tested using the following parameter ranges:

TABLE 9

| Parameter | | | | |
|---|---|---|---|---|
| n_estimators | 100 | 200 | 500 | 1000 |
| learning_rate | 0.01 | 0.05 | 0.1 | 0.3 |
| max_depth | 3 | 5 | 7 | 8 |
| gamma | 0 | 0.1 | 0.5 | 1 |
| subsample | 0.5 | 0.8 | 1 | |
| colsample_bytree | 0.5 | 0.7 | 0.8 | 1 |
| reg_alpha | 0 | 1 | 5 | |
| reg_lambda | 0 | 1 | 5 | |
| min_child_weight | 1 | 5 | 10 | |

### Final Hyperparameters

The best-performing configuration identified was:

| | |
|---|---|
| a. | { |
| | n_estimators: 1000, |
| | learning_rate: 0.01, |
| | max_depth: 8, |
| | gamma: 0.1, |
| | subsample: 0.8, |
| | colsample_bytree: 0.5, |
| | reg_alpha: 0, |
| | reg_lambda: 0, |
| | min_child_weight: 5 |
| | } |

### 3.4. Model Performance Summary

### 3.4.1 Summary Metrics

Table 10 summarizes the final model's predictive performance based on cross-validation results from the hyperparameter sweep.

TABLE 10
Model Performance Metrics

| Metric | Value | Description |
|---|---|---|
| MAPE | 5.712131 | Mean Absolute Percentage Error |
| MAPE Std. Dev. | 0.2187747 | Variability in MAPE across runs |
| MSE | 0.0082121 | Mean Squared Error |
| MSE Std. Dev. | 0.0005053 | Variability in MSE across runs |

### 3.4.2 Interpretation of Metrics

### Mean Absolute Percentage Error (MAPE).

MAPE measures the average percentage difference between predicted and actual contract lease prices:

$$MAPE = \frac{1}{n} \sum \vert \frac{Actual - Predicted}{Actual} \vert \times 100$$

A MAPE of 5.712% indicates that, on average, the model's predictions deviate from true market lease prices by approximately 5.7%. Model “accuracy” is expressed as:

$$Accuracy = 100 - MAPE = 94.288 \%$$

This value reflects the mean closeness of predictions to actual lease prices on a percentage basis.

### MAPE Standard Deviation.

The standard deviation of 0.2188 indicates that the model's error is consistent and does not fluctuate significantly across the evaluated runs. Lower variability implies stable performance and reliable generalization.

### Mean Squared Error (MSE).

MSE measures the average squared difference between predicted and actual lease price values:

$${MSE = \frac{1}{n} \sum ( Actual - Predicted )}^{2}$$

A value of 0.0082 shows that absolute prediction errors (in lease price units) remain small, with large deviations being heavily penalized.

### MSE Standard Deviation.

An MSE standard deviation of 0.000505 reflects low dispersion across model runs. Low variance indicates that the model performs consistently and is not highly sensitive to training subsets.

### Combined Interpretation.

Together, these metrics demonstrate that the final model, as an Automated Valuation Model (AVM), is:

Highly accurate in percentage terms (MAPE-based accuracy of 94.3%),

Stable and reproducible (low standard deviations), and

Effective at minimizing both percentage error and absolute squared error.

The AVM exhibits strong predictive performance appropriate for production-level valuation workflows.

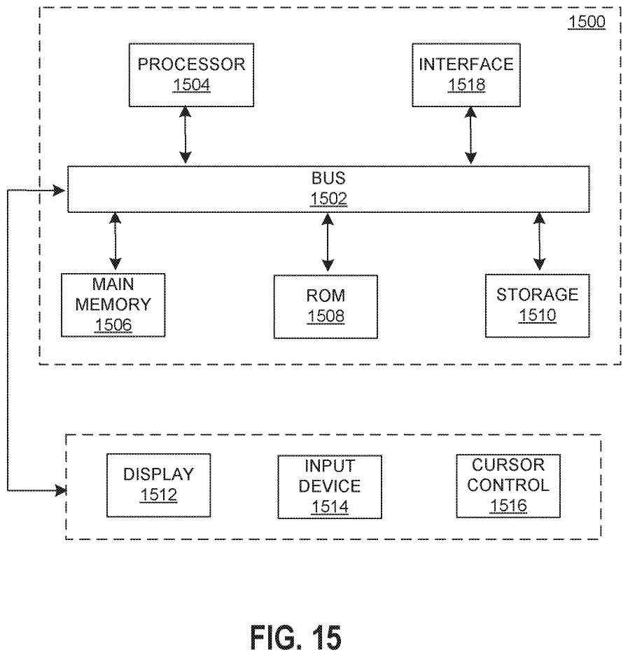

FIG. 15 depicts a block diagram of an example computer system 1500. Computing system 1500 is a computing device of which various embodiments of the present disclosure may be implemented. Computer system 1500 includes a bus 1502 or other communication mechanism for communicating information, one or more hardware processors 1504 coupled with bus 1502 for processing information. Hardware processor(s) 1504 may be, for example, one or more general purpose microprocessors.

Computer system 1500 also includes a main memory 1506, such as a random access memory (RAM), cache and/or other dynamic storage devices, coupled to bus 1502 for storing information and instructions to be executed by processor 1504. Main memory 1506 also may be used for storing temporary variables or other intermediate information during execution of instructions to be executed by processor 1504. Such instructions, when stored in computer readable memory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk, optical disk, or USB thumb drive (Flash drive), etc., is provided and coupled to bus 1502 for storing information and instructions.

Computer system 1500 may be coupled via bus 1502 to a display 1512, such as a liquid crystal display (or touch screen), for displaying information to a computer user. An input device 1514, including alphanumeric and other keys, may be coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. In some embodiments, the same direction information and command selections as cursor control may be implemented via receiving touches on a touch screen without a cursor.

Computing system 1500 may include a user interface stage to implement a graphical user interface (GUI) that may be stored in a mass storage device as executable software codes that are executed by the computing device(s). This and other stages may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, may refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable memory storage medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor(s) 1504 executing one or more sequences of one or more instructions contained in main memory 1506. Such instructions may be read into main memory 1506 from another computer readable memory storage medium, such as storage device 1510. Execution of the sequences of instructions contained in main memory 1506 causes processor(s) 1504 to perform the process steps described herein. In alternative embodiments, hard-wired circuitry may be used in place of or in combination with software instructions.

The term “non-transitory media,” “computer readable medium,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1510. Volatile media includes dynamic memory, such as main memory 1506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1502. Transmission media may also take the form of acoustic or light waves, such as those generated during radio-wave and infrared data communications.

Computer system 1500 also includes interface 1518 coupled to bus 1502. Interface 1518 provides a two-way data communication coupling to one or more network links that are connected to one or more local networks. For example, interface 1518 may be an integrated services digital network (ISDN) card, cable modem, satellite modem, or a modem to provide a data communication connection to a corresponding type of telephone line. As another example, interface 1518 may be a local area network (LAN) card to provide a data communication connection to a compatible LAN (or WAN component to communicate with a WAN). Wireless links may also be implemented. In any such implementation, interface 1518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through interface 1518, which carry the digital data to and from computer system 1500, are example forms of transmission media.

Computer system 1500 may send messages and receive data, including program code, through the network(s), network link and interface 1518. In the Internet example, a server may transmit a requested code for an application program through the Internet, the ISP, the local network and interface 1518.

The received code may be executed by processor 1504 as it is received, and/or stored in storage device 1510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto may be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described may be shared in part or in total among one or more circuits. Even though various features or elements of functionality may be individually described or claimed as separate circuits, these features and functionality may be shared among one or more common circuits, and such description shall not require or imply that separate circuits are required to implement such features or functionality. Where a circuit is implemented in whole or in part using software, such software may be implemented to operate with a computing or processing system capable of carrying out the functionality described with respect thereto, such as computer system 1500.

As used herein, the term “or” may be construed in either an inclusive or exclusive sense. Moreover, the description of resources, operations, or structures in the singular shall not be read to exclude the plural. Conditional language, such as, among others, “may,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

What is claimed is:

1. A system comprising:
at least one processor configured to:
receive time-indexed data comprising values of a plurality of features;
generate derived features based on temporal changes of at least one of the plurality of features, the derived features including at least a first derivative of a first value;
temporally align the plurality of features and the derived features to a reference date such that only data available prior to the reference date is used for training a machine learning model;
train a machine learning model on the temporally aligned features and the derived features to predict a forward-looking value; and
output the forward-looking value.

2. The system of claim 1, wherein the first derivative, and a second derivative of the first value, respectively represent within the machine learning model a velocity and an acceleration for the first value over a predetermined period of time.

3. The system of claim 2, wherein the first value is an interest rate or an inflation rate for the predetermined period of time.

4. The system of claim 1, wherein the first derivative, and a second derivative of at least one of the first value or a second value, respectively represent within the machine learning model a velocity and an acceleration over a predetermined period of time, wherein the second value is from the derived features.

5. The system of claim 2, wherein the first value is a macroeconomic indicator for the predetermined period of time.

6. The system of claim 1, wherein the first derivative is a macroeconomic feature.

7. The system of claim 1, wherein the machine learning model implements a gradient boosting model.

8. The system of claim 1, wherein the derived features are determined to represent a term.

9. The system of claim 8, wherein the term includes at least one of a year term or predetermined number of month term.

10. The system of claim 1, wherein the first value is a macroeconomic indicator.

11. The system of claim 10, wherein the macroeconomic indicator is an interest rate or an inflation rate.

12. A method comprising:
controlling, by at least one processor:
receiving time-indexed data comprising values of a plurality of features;
generating derived features based on temporal changes of at least one of the plurality of features, the derived features including at least a first derivative of a first value;
temporally aligning the plurality of features and the derived features to a reference date such that only data available prior to the reference date is used for training a machine learning model;
training a machine learning model on the temporally aligned features and the derived features to predict a forward-looking value; and
outputting the forward-looking value.

13. The method of claim 12, wherein the first derivative, and a second derivative of the first value, respectively represent within the machine learning model a velocity and an acceleration for the first value over a predetermined period of time.

14. The method of claim 13, wherein the first value is an interest rate or an inflation rate for the predetermined period of time.

15. The method of claim 12, wherein the first derivative, and a second derivative of at least one of the first value or a second value, respectively represent within the machine learning model a velocity and an acceleration over a predetermined period of time, wherein the second value is from the derived features.

16. The method of claim 13, wherein the first value is a macroeconomic indicator for the predetermined period of time.

17. The method of claim 12, wherein the first derivative is a macroeconomic feature.

18. The method of claim 12, wherein the machine learning model implements a gradient boosting model.

19. The method of claim 12, wherein the derived features are determined to represent a term.

20. The method of claim 12, wherein the term includes at least one of a year term or predetermined number of month term.
